(19) United States
(12) Patent Application Publication
(10) Pub. No.: US 2009/0310019 A1
(43) Pub. Date: Dec. 17, 2009

(54) IMAGE DATA PROCESSING APPARATUS AND METHOD, AND RECEPTION APPARATUS

(75) Inventor: Katsuya Ohno, Kokubunji-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/392,860

(22) Filed: Feb. 25, 2009

(30) Foreign Application Priority Data
Jun. 13, 2008 (JP) 2008-155614

(51) Int. Cl. H04N 5/44; G09G 5/00

(52) U.S. Cl. 348/553; 345/619; 348/E05.096

(57) ABSTRACT

According to one embodiment, an embodiment of the present invention minimizes visibility of noise effect in a display image caused by an image data error and maintains the quality of the display image with inexpensive circuit. The embodiment includes an image data reception module which receives image data to which an error check code is added per predetermined processing unit, an error detection module which detects an error of the received image data, and an image data output module which outputs specific image data to replace the image data in which the error is detected.

### CROSS-REFERENCE TO RELATED APPLICATIONS

This application is based upon and claims the benefit of priority from Japanese Patent Application No. 2008-155614, filed Jun. 13, 2008, the entire contents of which are incorporated herein by reference.

### BACKGROUND

1. Field

One embodiment of the invention relates to an image data processing apparatus and method, and a reception apparatus, in which, in particular, the noise of a display image can be minimized by utilizing an error check code and the quality of the display image is maintained.

2. Description of the Related Art

In the image data processing technology, technologies of performing error detection and correction when an error occurs in image data in process are disclosed in various documents. Further, a technology of performing initialization of an image data processing block in which an error occurs among a plurality of image data processing blocks is disclosed (for example, Jpn. Pat. Appln. KOKAI Publication No. 2002-185678).

The conventional technologies require a processing circuit or software which is relatively complicated and heavy-loaded with error detection, error correction process and the like.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a structural explanatory diagram showing an embodiment of the present invention;

FIG. 2 is a flowchart showing an operation example of an apparatus of the present invention;

FIGS. 3A to 3C are diagrams showing examples of a unit block (a unit to which an error check code is added) which is utilized in the present invention;

FIGS. 4A and 4B are diagrams showing overviews of a television reception apparatus and a recording/reproducing apparatus to which the present invention is applied; and

FIG. 5 is an explanatory diagram showing an example of an inner structure of the television reception apparatus shown in FIG. 4.

### DETAILED DESCRIPTION

Various embodiments according to the invention will be described hereinafter with reference to the accompanying drawings.

According to an embodiment of the present invention, visibility of noise effect in a display image caused by an image data error can be minimized and the quality of the display image can be maintained with inexpensive means.

According to one aspect of the present invention, there is provided an image data processing apparatus comprising: an image data reception module configured to receive image data to which an error check code is added per predetermined processing unit; an error detection module configured to detect an error of the received image data; and an image data output module configured to output specific image data to replace the image data in which the error is detected.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

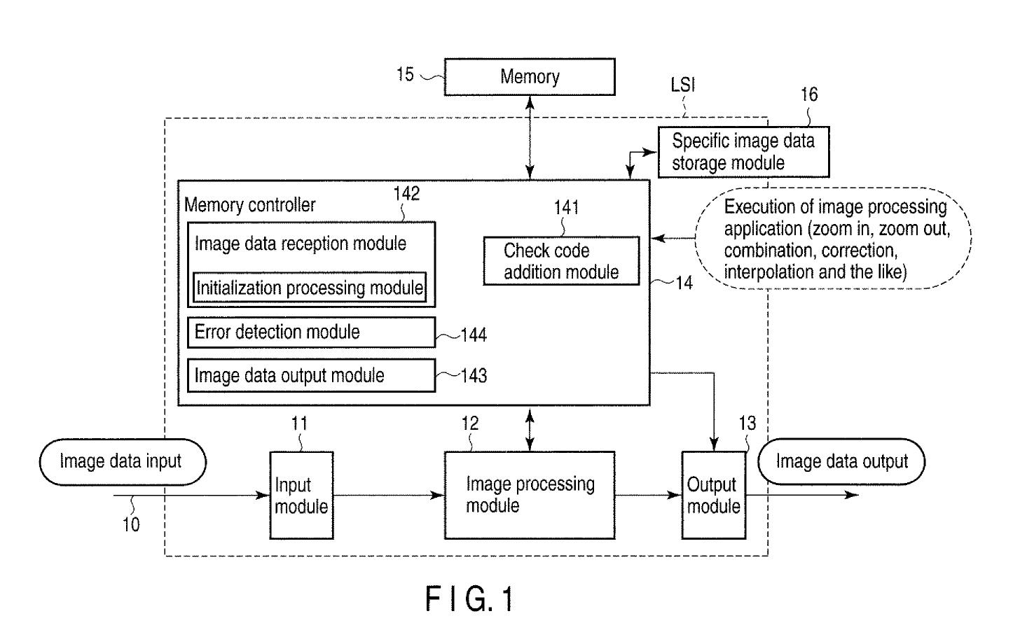

Specific explanation will be disclosed in the following. FIG. 1 is a diagram showing a basic structure of the present invention. In FIG. 1, for example, image data from outside is input to an input terminal 10. The image data is input to an image processing module 12 via an input module 11, and image processing corresponding to an application is performed. Then, the image data is output to an external apparatus, such as a display module or a recording/reproducing apparatus etc., via an output module 13. The whole process is controlled by a controller 14.

In the image processing module 12, there is a case that a memory 15 is necessary as a temporarily buffer to process the image data. For the memory 15, memories such as DDR2 or SDRAM are utilized.

In the abovementioned apparatus, when the image data is temporarily stored in the memory 15, the image data is stored with an error check code added per pixel unit, line unit or frame unit. Accordingly, the controller 14 includes a check code addition module 141. The controller 14 includes an image data reception module 142 for capturing the image data from the image processing module 12. The image data reception module 142 also has a function of capturing the image data from the memory 15.

Further, the controller 14 includes an image data output module 143. The image data output module 143 has a function of outputting the image data to the memory 15 to be used for the process, a function of outputting the image data to the image processing module 12 to be used for the process and a function of outputting the processed image data to the output module 13. The memory 15 can be also utilized to confirm the image data before the processing and the image data after the processing. Further, as described later, the image data output module 143 has a function of replacing the image data with specific image data at the output module 13 at the timing of outputting the image data when the image data in which an error is detected exists. The error detection is performed at the error detection module 144. The abovementioned specific image data can be stored in a specific image data storage module 16. The abovementioned memory 15 is used by being connected to the outside of the LSI, for example. Accordingly, the present Invention effectively functions in a case that an error occurs in the memory 15.

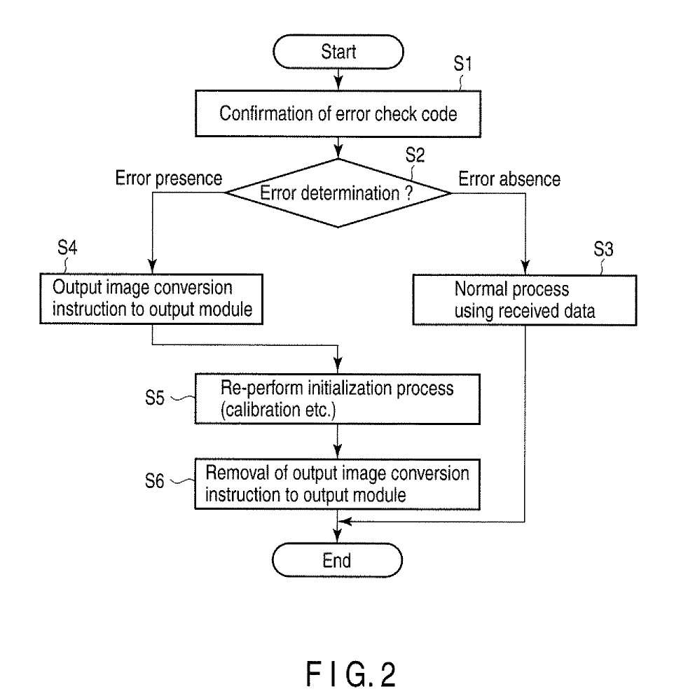

FIG. 2 is a flowchart showing a normal process and a conversion process with the specific image data which are performed in accordance with the situation of the error detection of the image data which is captured from the memory 15. First, the error check code is confirmed when the image data is captured from the memory 15 (block S1). Then, error determination is performed (block S2). When an error does not exist, the normal process using the received data is performed (block S3). The image data in which an error is not detected is output without the replacement process.

On the contrary, when an error is detected, the output module 13, for example, is instructed to perform replacement process against the unit block in which the error occurs. The replacement data can be a specific color (blue or black, for example) and the like.

For the memory 15, the case that a data obtaining position is shifted due to disturbance and the like can be considered as a factor for causing the abovementioned error. In the case of the abovementioned SDRAM, the data can be obtained by the strobe by adjusting the data strobe and the data phase. Here, when the adjusting position is shifted, the normal image data cannot be obtained and derangement of the image is caused.

Therefore, in this apparatus, it is also possible to further add a process of re-performing an initialization process, such as a memory calibration (block S5). That is, when an error is detected in the image data, it is also possible to dispose a processing module which performs initialization of the memory 15. the processing module is provided in the controller, for example. Here, it is preferred that the process is performed after all of the data stored in the memory 15 are read. This is because normal data may also exist. After the abovementioned process, the conversion instruction of the output image data to the output module 13 is removed.

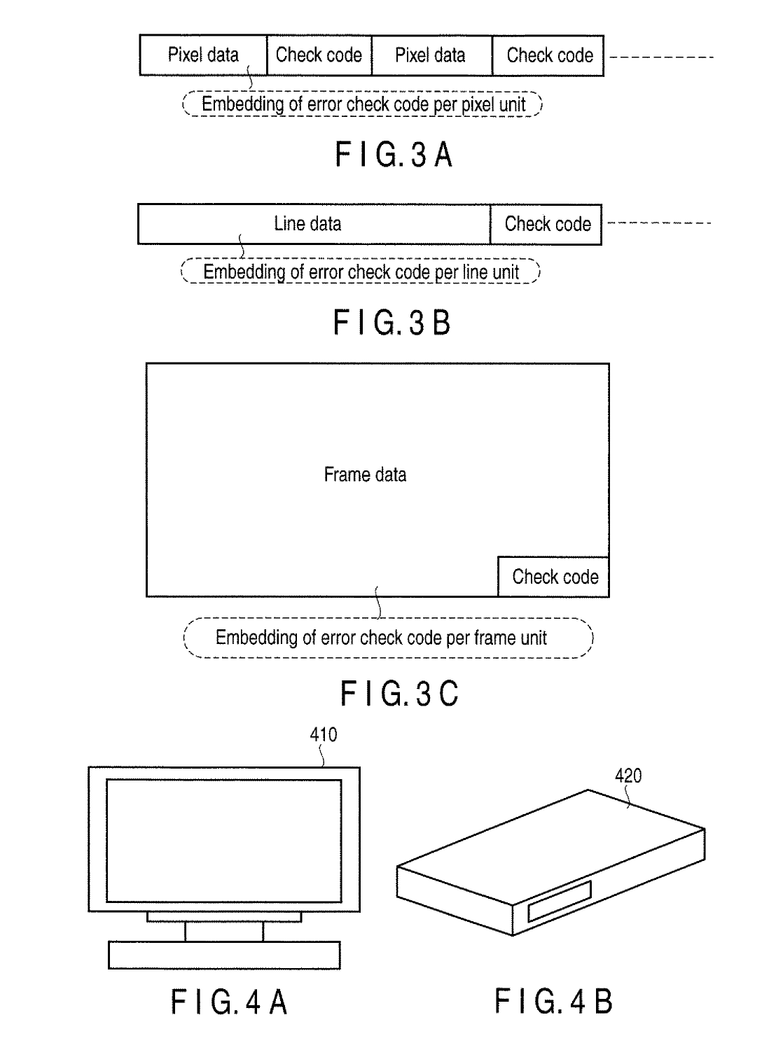

Various examples of the unit block to which the error check code is added are shown in FIGS. 3A to 3C. The unit to which the error check code is added can be a unit of pixel data as shown in FIG. 3A, a unit of a line as shown in FIG. 3B or a unit of a frame as shown in FIG. 3C. Alternatively, though not shown in figures, the unit can be a unit of plural pixels or a unit of plural lines.

In the abovementioned explanation, when the image data is stored, the image data is stored in the memory 15 with the error check code added, and the error detection is performed when the image data is captured from the memory 15.

However, the present invention is not limited to this embodiment. The error detection can be performed also in the case where the error check code is added to the image data which is captured by the image processing module 12 via the input module 11. In this case, the image data reception module 142 can also capture the image data to which the error check code is added via the interface (the input module 11, image processing module 12). Then, when an error occurs, the replacement process with the specific image data is performed at the output module 13.

Further, in the above explanation, the addition of the error check code per pixel unit, the addition of the error check code per line unit and the addition of the error check code per frame unit have been explained. Here, it is also possible to selectively switch the unit block appropriately corresponding to the processing mode of the image data. For example, it is also possible that the error detection is performed per pixel data unit in the case of image data processing per fine unit (smoothing process and the like, for example) and the error detection is performed per line unit in the case of processing per line unit (image division, image combination per area unit which is relatively large and the like, for example).

Further, in the present invention, it is also possible to simply utilize the data retaining function of a liquid crystal display device (LCD). Elements of a display panel of some LCDs retain data. Accordingly, the pixel display of the previous state can be obtained by not supplying output data to the portion of the corresponding element when an error is detected Namely, it is realized with a control signal (a data enable signal, a synchronization signal) of the output image being made to be in a non-active state.

FIGS. 4A and 4B show overviews of a television reception apparatus and a recording/reproducing apparatus to which the present invention is applied.

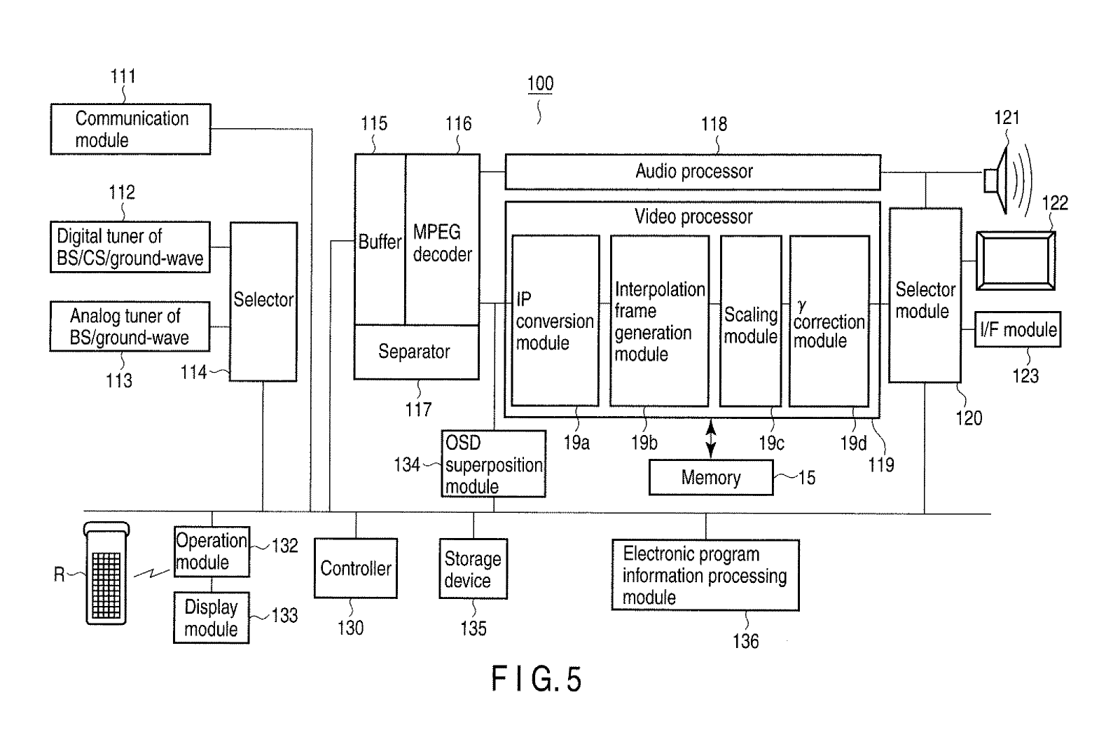

FIG. 5 shows a structural example of the television reception apparatus 100. In FIG. 5, a controller 130 of the television reception apparatus 100 is connected to various portions via a data bus to control the whole operation. As main components, the television reception apparatus 100 includes an MPEG decoder 116 for reproduction and the controller 130 for controlling the operation of the apparatus. The television reception apparatus 100 has a selector 114 of the input side and a selector module 120 of the output side. A digital tuner 112 of BS/CS/ground-wave and an analog tuner 113 of BS/ground-wave are connected to the selector 114 of the input side. Further, a communication module 11 having a LAN etc. and a mail function is disposed to he connected to the data bus.

The television reception apparatus 100 further includes a buffer 115 which temporarily stores a demodulation signal from the digital tuner 112 of BS/CS/ground-wave, a separator 117 which separates by kind the packet which is the stored demodulation signal, the MPEG decoder 116 which performs the MPEG decoding process to the packet for video-audio supplied from the separator 117 and outputs the video-audio signal, and an OSD (On Screen Display) superposition module 134 which generates a video signal for superposing operational information etc. and superposes the signal on the video signal.

The television reception apparatus 100 further includes an audio processor 118 which performs amplification process etc. to the audio signal from the MPEG decoder 116 and a video processor 119 which performs desired video process after receiving the video signal from the MPEG decoder 116.

Further, the television reception apparatus 100 includes a selector module 120 which selects where the audio signal and the video signal are to be output, a speaker module 121 which outputs audio in accordance with the audio signal from the audio processor 118, a display module 122 which is connected to the selector module 120 and displays the video at a liquid crystal display screen etc. in accordance with the supplied video signal, and an interface module 123 which communicates with the external apparatus.

Further, the television reception apparatus 100 includes a storage device 135 which stores video information etc. from the digital tuner 112 of BS/CS/ground-wave and the analog tuner 113 of BS/ground-wave and an electronic program information processing module 136 which obtains electronic program information from a broadcast signal etc. and performs screen display etc. These are connected to the controller 130 via the data bus.

The television reception apparatus 100 further includes an operation module 132 which is connected to the controller 130 via the data bus and which receives operation of a user and operation of a remote control unit R and a display module 133 which displays the operational signal. Here, the remote control unit R is capable of performing nearly the same operation as the operation module 132 which is arranged at the main body of the television reception apparatus 100. The remote control unit R can perform various settings such as operation of the tuner etc.

In the abovementioned television reception apparatus 100, the broadcast signal is input to the digital tuner 112 of the BS/CS/ground-wave etc. from a reception antenna, and tuning is performed therein. The packet form demodulation signal which is tuned and demodulated is separated into packets by kind by the separator 117. Then, the packet for audio is decoded at the MPEG decoder 116 etc. and becomes an audio signal which is then supplied to the audio processor 118. Further, the packet for video is decoded at the MPEG decoder 116 etc. and becomes a video signal which is then supplied to the video processor 119.

In the video processor 119, the supplied video signal is subjected to the image process, such as conversion of the interlace signal to the progressive signal by an IP conversion module 19a, for example. Further, an interpolation image can be provided by an interpolation frame generation module 19b. Then, the processed signal is supplied to the selector module 120 via a scaling module 19c and a y correction module 19d.

The selector module 120 supplies the video signal to the display module 122, for example, corresponding to the control signal of the controller 130. Accordingly, the video corresponding to the video signal is displayed at the display module 122. In addition, the audio corresponding to the audio signal from the audio processor 118 is output by the speaker module 121.

Further, various operational information and caption information etc. which are generated at the OSD superposition module 134 are superposed on the video signal corresponding to the broadcast signal. The video corresponding to the above is displayed at the display module 122 via the video processor 119.

The memory 15 is utilized at the abovementioned video processor 119. As explained above, the error check code is added to the image data which is stored in the memory 15, and the error detection is performed when the image data is read. In this manner, visibility of noise effect in the display image can be minimized with simple means and the quality of the display image can be maintained with inexpensive means.

Here, the check code addition module 141, the image data reception module 142, the image data output module 143 and the error detection module 144 shown in FIG. 1 can be arranged in the video processor 119 or can be arranged in the controller 130.

While certain embodiments of the invention have been described, these embodiments have been presented by way of example only, and are not intended to limit the scope of the invention. Indeed, the novel methods and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. An image data processing apparatus comprising:
an image data reception module configured to receive image data to which an error check code is added per predetermined processing unit;
an error detection module configured to detect an error of the received image data; and
an image data output module configured to output specific image data to replace the image data in which the error is detected.

2. The image data processing apparatus of claim 1,
wherein the image data in which the error is not detected is output without performing the replacement process.

3. The image data processing apparatus of claim 1, further comprising a memory configured to store the image data,
wherein the image data reception module reads the image data which is output from the memory and to which the error check code is added and includes an initialization processing module which initializes the memory when an error is detected in the image data.

4. The image data processing apparatus of claim 1,
wherein the image data reception module reads the image data to which the error check code is added via an input module.

5. The image data processing apparatus of claim 1,
wherein the predetermined processing unit is any of a pixel unit, a line unit and a frame unit.

6. An image data processing method comprising:
capturing image data to which an error check code is added per predetermined processing unit;
detecting an error of the captured image data; and
outputting specific image data to replace the image data in which the error is detected.

7. The image data processing method of claim 6,
wherein the image data in which the error is not detected is output without performing the replacement process.

8. The image data processing method of claim 6, further comprising:
receiving image data without an error check code; and
storing the image data in a memory with the error check code added at the time of storing.

9. The image data processing method of claim 6,
wherein an output module of the image data is made to be in a non-active state when an error is detected in the image data.

10. A television reception apparatus comprising:
an image data reception module configured to receive image data to which an error check code is added per predetermined processing unit;
an error detection module configured to detect an error of the received image data; and
an image data output module configured to output specific image data to replace the image data in which the error is detected.
